(19) United States
(12) Patent Application Publication
(10) Pub. No.: US 2008/0086471 A1
(43) Pub. Date: Apr. 10, 2008

(54) Method and system for sharing bookmarks amongst a community of academic system users

(76) Inventors: Greg Ritter, Washington, DC (US); Karen Gage, Washington, DC (US); Sundara Chintaluri, Oak Hill, VA (US)

Correspondence Address: MCDERMOTT, WILL & EMERY, 4370 LA JOLLA VILLAGE DRIVE, SUITE 700, SAN DIEGO, CA, 92122, US

(21) Appl. No.: 11/544,303

(22) Filed: Oct. 6, 2006

(51) Int. Cl. G06F 17/30

(52) U.S. Cl. 707/8

(57) ABSTRACT

A system of hardware and software provides a community of academic institution-related users with a central repository for storing, searching, and retrieving bookmarks from amongst the users. The bookmarks are tagged with user-specified labels as well as academic institution related metadata such as a course identifier and/or discipline identifier. As a result, other users can search through the bookmarks using a variety of criteria to locate relevant bookmarks and other information.

### BACKGROUND

1. Field

The present disclosure relates generally to computer software and hardware systems, and more particularly, to such a system for online social communities of users

2. Background

As part of providing quality educational opportunities, many academic institutions are providing online systems that support and augment traditional classroom courses. These online systems provide functionality to disseminate information to students, to allow collection of student assignments and homework, to provide interactive educational experiences, and to interface with other campus-related systems and services.

Independently, communities of online users have discovered that social networks can occur by sharing personal information and content with other users. This content can include files of various types such as photos, videos, blogs, and the like. One particular type of information that users may share is a list of “favorites” or bookmarks that identify various network-based resources. As with a lot of the information available on the Internet, the usefulness and relevance of shared bookmarks are dependent on the owner of the bookmarks and their personal attributes. For example, the usefulness of culinary-related bookmarks may vary greatly depending on whether the owner of the bookmarks is a kindergarten student as compared to a gourmet chef.

Accordingly, there exists a need within the universe of academic users and institutions for methods and systems that allow identifying, sharing and searching of bookmarks and other information in a manner that is relevant and useful.

### SUMMARY

Accordingly, one aspect of the present invention relates to a method for collecting a plurality of bookmarks. In accordance with this method, a user of an academic system is authenticated and then a bookmark may be received from the user. A tag related to the bookmark is also received and then the tag and the bookmark are stored in a community bookmark repository.

Another aspect of the present invention relates to a method for providing bookmarks from a community bookmark repository. In accordance with this method a user of an academic system in communication with the community bookmark repository is authenticated. Then a query interface is presented to the user and, in response, a search query is received from the user. One or more bookmarks in the community bookmark repository matching the search query are located and then presented to the user.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Various aspects of an institutional assessment system are illustrated by way of example, and not by way of limitation, in the accompanying drawings, wherein:

FIG. 1 illustrates a block-level diagram of an institutional environment in which an assessment system is implemented in accordance with the principles of the present invention;

FIG. 2 depicts a block diagram of a community bookmark site in communication with a plurality of academic systems;

FIG. 3A depicts a flowchart of an exemplary method of storing bookmarks in accordance with the principles of the present invention;

FIGS. 3B and 3C depict an exemplary user interface for storing bookmarks in accordance with the principles of the present invention;

FIG. 4A depicts a flowchart of an exemplary method of searching for bookmarks from a community bookmark site;

FIG. 4B depicts an exemplary user interface for searching a community bookmark site for matching bookmarks; and

FIGS. 5A-5H include exemplary depictions of a user interface related to aspects of a community bookmark site.

The figures include a number of different screen shots of an exemplary user interface. One of ordinary skill will appreciate that the depicted interface is provided by way of example and that the layout, options and items on each screen shot may be altered or augmented without departing from the scope of the present invention.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention. Additionally, the term “automatic” may be used herein to describe one or more process steps that may be performed in an automated manner using various types of programmable processors or computers. However, one of ordinary skill will recognize that the performance of these steps may also be accomplished manually or via a combination of manual and automated processes.

While many examples are provided herein that specifically include a higher-education institution, the principles of the present invention contemplate other types of institutions as well. For example, corporations, governmental entities, and K-12 institutions are all considered within the scope of the present invention. An institution may also be a consortium of schools and/or campuses.

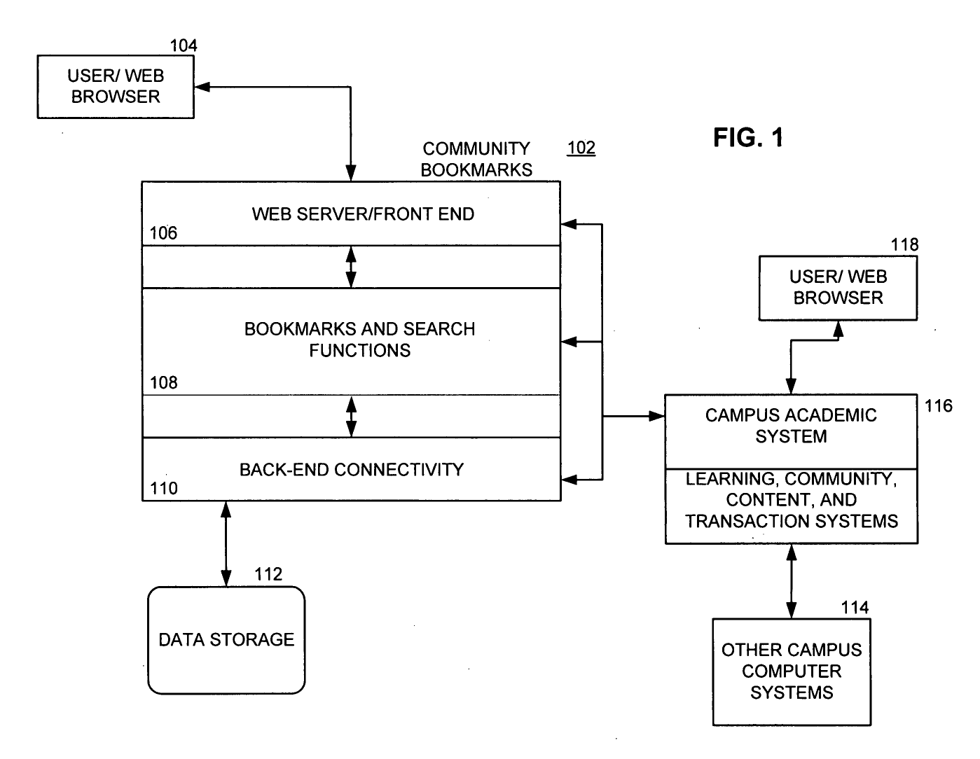

FIG. 1 depicts a functional block diagram of an exemplary environment for a community bookmark system 102 in accordance with the principles of the present invention. As described in more detail herein, the system 102 provides a framework for collecting, searching, and sharing bookmarks amongst a community of users. A user 104 of the system 102 typically uses a web browser or similar interface to communicate with an appropriately configured front-end 106 of the system 102. For example, the front-end 106 may be a web server hosting a number of applications 108 that the user 104 may access. The applications 108 are one or more software components or programs that execute on a programmable computer platform to provide functionality related to users performing bookmark-related activities. The applications 108 may also access data storage facilities 112 that can store both bookmark-related information as well as account and user information

Another resource to which the back end 110 may provide connectivity is a campus (or institutional) academic system 116. An example of such a system is provided by the present Assignee under the name Academic Suite™ with many features thereof described in U.S. Pat. No. 6,998,138 entitled “Internet-Based Education Support System and Methods”, the disclosure of which is incorporated herein in its entirety. As described in that patent, the campus academic system 116, in an academic environment, provides a platform that allows students and teachers to interact in a virtual environment based on the courses for which the student is enrolled. This system may be logically separated into different components such as a learning system, a content system, a community system, and a transaction system. An example of such a student is the user 118 that can access the academic system 116 via a web browser or similar interface. The user 118 may also be faculty, staff or an administrative officer. An example of these separate components of the system 116 are described in detail in pending patent applications “Method and System for Conducting Online Transactions (Ser. No. 10,373,924 filed Feb. 25, 2003), “Content and Portal Systems and Associated Methods” (Ser. No. 11/142,965 filed Jun. 2, 2005), and “Content System and Associated Methods” (Ser. No. 10/918,016 filed Aug. 13, 2004), all of which are incorporated herein by reference in their entirety.

Various other computer systems 114 may be connected to the academic system 116 as well. The other computer systems 114 may be a variety of third-party systems that contain data or resources that are useful for the academic system 116. In the exemplary higher education environment, the systems 114 may include a student information system (SIS) that maintains student demographic information as would be appreciated by one of ordinary skill. The systems 114 may also include an electronically maintained class, or course, schedule for the institution that includes information about the courses such as section numbers, professors, class size, department, college, etc. Other campus-related systems such as financial aid and the bursar's office may be included in the systems 114 of FIG. 1.

Of particular usefulness to the community bookmark system 102, the academic system 116 provides a virtual space that the user 118 may visit to receive information and to provide information. One exemplary arrangement provides the user 118 with a home page where general information may be located and that has links to access course-specific pages where course-specific information is located. As explained in the incorporated patent and patent applications, electronic messaging, electronic drop boxes, and executable modules may be provided within the user's virtual space on the academic system 116. Thus, with respect to the community bookmark system 102, one of the applications 108 may be used to receive information, commands, and/or search queries from one or more users of the academic system 116. Via the back-end 110, the information may be sent to the academic system 116 where it is made available to the user 118 just as any other information is made available. Similarly, from within the academic system 116, the user may enter and submit data that is routed through the back end 110 to one of the applications 108. One of ordinary skill will recognize that in at least one alternative embodiment, the academic system 116 and the community bookmark system 102 may be more closely integrated so that the connectivity between the applications 108 and the system 116 is achieved without a network connection or special back end software 110.

Although the front end 106, applications 108, and back end 110 of the community bookmark system 102 are each depicted as a single block in FIG. 1, one of ordinary skill will appreciate that each may also be implemented using a number of discrete, interconnected components. As for the communication pathways between the various blocks of FIG. 1, a variety of functionally equivalent arrangements may be utilized. For example, some pathways may be via the Internet or other wide-area network, while other pathways may be via a local-area network or even a wireless interface. Also, although only a single user 104 of the community bookmark system 102 is explicitly shown, multiple users are not only contemplated but are very likely within the environment of FIG. 1. The structure of FIG. 1 is logical in nature and does not necessarily reflect the physical structure of such a system. For example, the community bookmark system 102 may be distributed across multiple computer platforms as can the data storage 108. Furthermore, the three components 106, 108, 110 are separate in the figure to simplify explanation of their respective operation. However, these functions may be performed by a number of different, individual components, or a more monolithically arranged component. Additionally, any of the three logical components 106, 108, 110 may directly communicate with the academic system 116 without an intermediary. Also, although the users 104, 118 are depicted as separate entities in FIG. 1, they may, in fact, be the same user or a single web browser instance concurrently accessing both the community bookmark system 102 and the academic system 116.

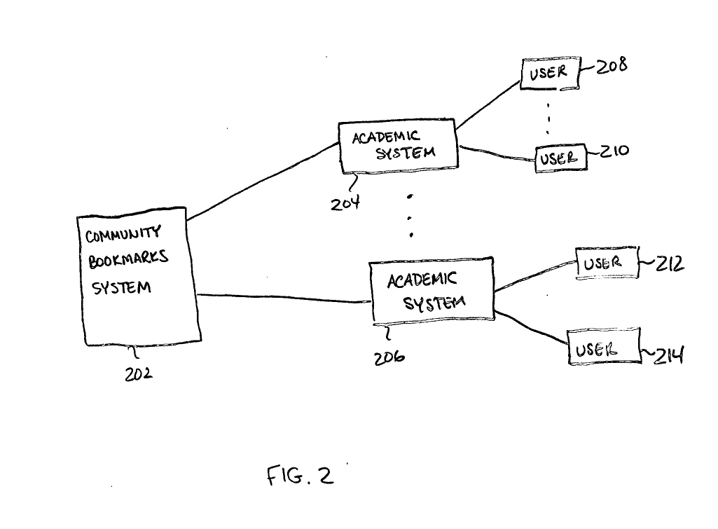

For example, the user 118 may be in communication with the academic system 116 of their respective educational institution and access the community bookmark system 102 through a hyperlink or other icon or link presented by the academic system 116. Alternatively, the user 104 may use a web browser to more directly access the community bookmark system 102 without using the academic system 116 as an intermediary. In both instances, the users 104, 118 may be identified and authenticated before allowing them access to the community bookmark system 102. In operation, it is contemplated that a plurality of campus academic systems 116 can communicate with the community bookmark system 102. Thus, users from a variety of different academic institutions may have access to the bookmark and search functions 108 of the system 102. FIG. 2 illustrates the concept of multiple academic systems 204, 206 being connected to the community bookmark system 202. The connection, although shown as a direct link, may be implemented over the Internet or some other network. Each academic system 204, 206 includes a plurality of respective users 208, 210, 212, 214 that are in communication therewith. A user (e.g., 208), while using the academic system 204, may advantageously utilize functionality and capabilities of the bookmark system 202, as explained further herein.

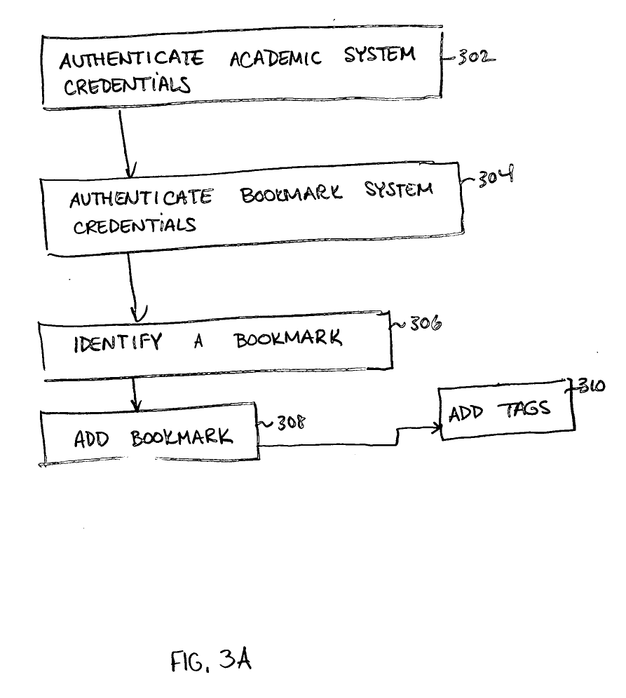

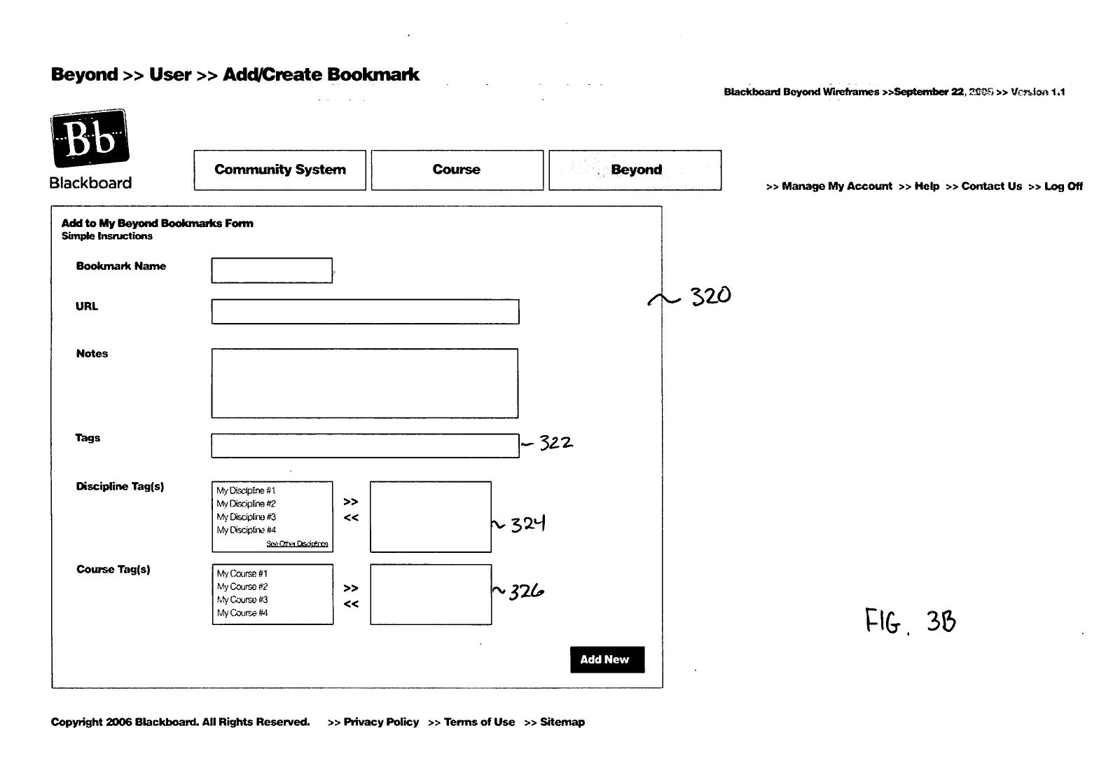

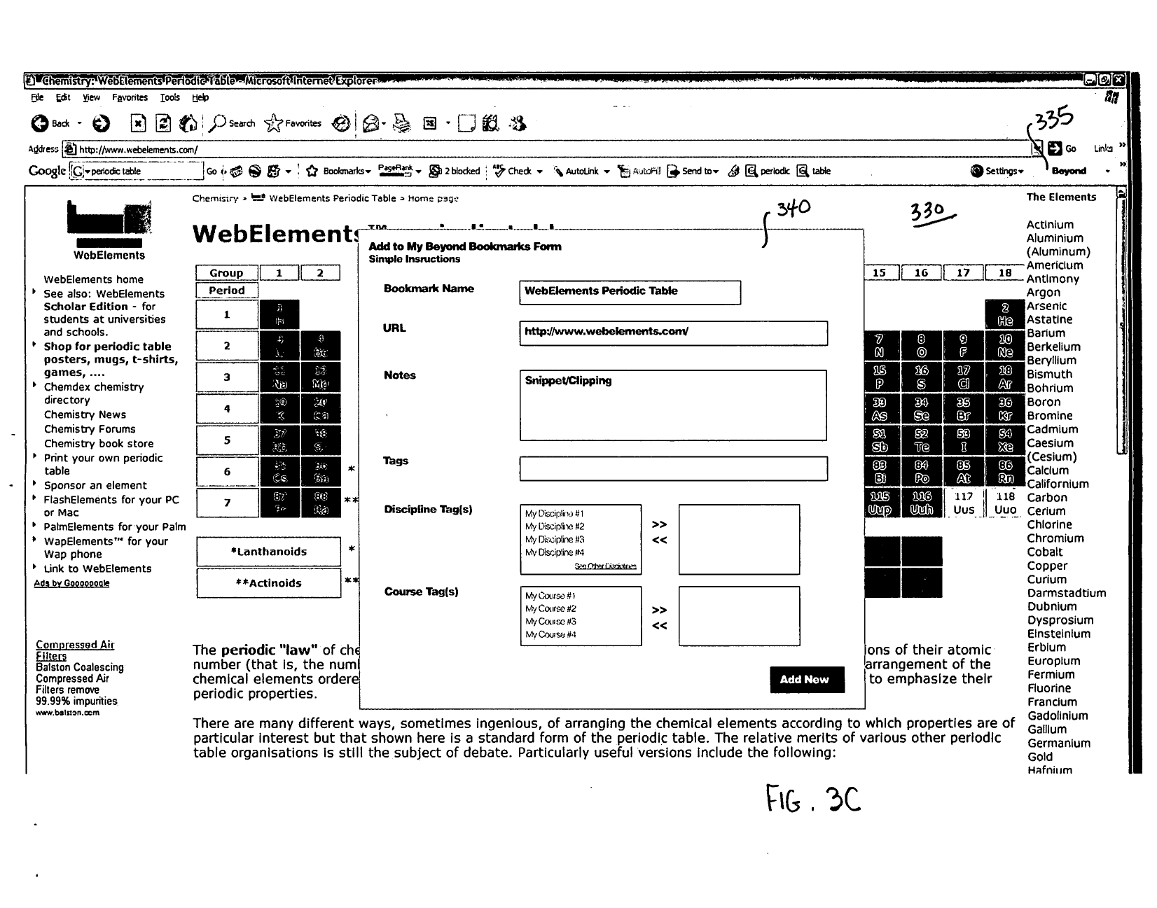

FIG. 3A illustrates a flowchart of an exemplary method for a user to store one or more bookmarks at a central community bookmark system such as that described with reference to FIGS. 1 and 2. According to this method, a user is first authenticated when accessing the academic system in step 302. This first step ensures that eventual users of the community bookmark system are limited to users having an account on an academic system. The user may be faculty, staff, student, or a combination of these; however, they do have an academic system account. As described in the incorporated patent and patent applications, the academic system includes methods and techniques for controlling access based on a user and their authenticated identity. Subsequently, the user, in step 304, may have their identity authenticated by the bookmark system.

The method of FIG. 3A includes two different authentication steps but one of ordinary skill will recognize that user authentication may occur in a variety of ways without departing from the intended scope of the present invention. For example, a user may have one community bookmark system identity that is associated with one or more academic system identities. A user may be a faculty member (or student) at two different academic institutions. Alternatively, a user may have completed undergraduate work at one institution and then moved on to graduate work at a second institution. In either case, it is advantageous for a single identity within the bookmark system to map to two different academic institution identities. In an alternative embodiment, a separate community bookmark system identity may be uniquely mapped to each potential academic institution identity of a user. Thus, a user may have a set of bookmarks associated with their identity as a faculty member at one institution and a second set of bookmarks associated with their identity as a graduate student at a second institution.

Additionally, the flowchart of FIG. 3A explicitly depicts an authentication step occurring with respect to the academic system identity. This portion of the flowchart is merely exemplary in nature and variations are contemplated within the scope of the present invention. For example, the authentication of the user's academic system identity may be performed only once in order for the user to be permitted to create an account within the community bookmark system. Once the bookmark system account is created, then the user need only authenticate this identity on the system as opposed to authenticating their academic system identity each time they want to access the bookmark system. Accordingly, when the user visits the community bookmark site, they complete one authentication step and then are allowed to access the system.

Within the virtual space associated with a user of the community bookmark system, regardless of the specific implementation of assigning identities, the user will identify a bookmark, in step 306, to include in their shared bookmarks. FIGS. 3B and 3C illustrate two exemplary user interface screens for adding a bookmark. In FIG. 3B, a user is presented with a screen 320 that provides a number of text boxes to complete. This screen can typically be presented, for example, in response to a user selecting an icon or other interface element designed to allow them to initiate adding a bookmark. The user would complete all the text boxes of screen 320 in order to identify and describe the bookmark. Of particular usefulness are the boxes for tags 322, discipline tags 324, and course tags 326, which can be added in step 310.

Tags 322 allow a user to identify one or more keywords or phrases that describe the bookmark according to their own scheme of classifying information. The discipline tags 324 and course tags 326 allow a user to identify scholastic information related to the bookmark. For example, if the bookmark is related to a “Basic Electronic Circuits” course and to the academic discipline of “Electrical Engineering”, then user could specify those tags in the appropriate boxes 324, 326. To simplify selecting such tags, the boxes 324, 326 can automatically be populated with information from the academic system for that particular user or from a taxonomy of discipline tags managed by the community bookmark system.

In one embodiment, a background dialog process between the community bookmark system and the academic system may identify the courses and disciplines associated with the user adding the bookmark. Additionally, the user can also be presented with other courses and disciplines available at the academic institution in a secondary window so that they can also identify bookmarks associated with courses or disciplines other than their own if they so desire. Also, the discipline information can include whether or not the student is a graduate student or undergraduate student. The course information, for example, can include semester information or section information such that “English 101, Fall 2005” is different than “English 101, Spring 2006” and “History 311, Section 112A” is different than “History 311, Section 114”.

In another embodiment, the community bookmark system may store a fixed system-defined hierarchical classification scheme because each academic institution may have a varied classification scheme for academic disciplines. According to this embodiment, the community bookmark system maintains a list (that may be hierarchically arranged) of discipline tags that can be presented to the user for selection when a bookmark is being added. Furthermore, because so many discipline tags are possible, the system may be arranged to help filter the tags presented to the user. For example, as part of the account creation process, the user may be able to select a list of favorite disciplines that they are likely to use when adding a bookmark. Thus, when the list of discipline tags is presented to a user, the list includes only those disciplines identified as the user's favorites. A “more” button, or link, can be provided to access the entire list of discipline tags if desired. According to this embodiment, therefore, the community bookmark system and the academic system do not necessarily have to exchange information related to discipline tags.

FIG. 3C illustrates a second interface screen 340 that can be selected when a web page 330 is being displayed. The user interface screen 340 is selected by clicking a “bookmarklet” 335 that is installed in the browser's toolbar. When the bookmarklet 335 is clicked, it gathers appropriate data from the web page 330 such as Title, URL, and any selected text. With that data, certain fields can be auto-populated (but remain editable). The tags, however, remain completely under control of the user. From either screen of FIG. 3B or 3C, the user will complete the process, in step 308, by adding the bookmark which will cause it, and its tags, to be stored in the community bookmark system in such a way that it is associated with the user who adds it.

As a result of the steps of FIG. 3A, a community bookmark system can be created. Such a system includes a number of bookmarks from a variety of different users that are all classified according to the schema (i.e., tags) of the users that added each bookmark. Additionally, the bookmarks may have other associated meta-data that is useful in classifying the bookmark. This other information can include demographic information about the owner of the bookmark. It may be beneficial to know which bookmarks are from students as opposed to faculty or which bookmarks belong to students at University of Maryland as opposed to West Point. Furthermore, the bookmarks can include associated meta-data that relates to a course or discipline at a particular institution.

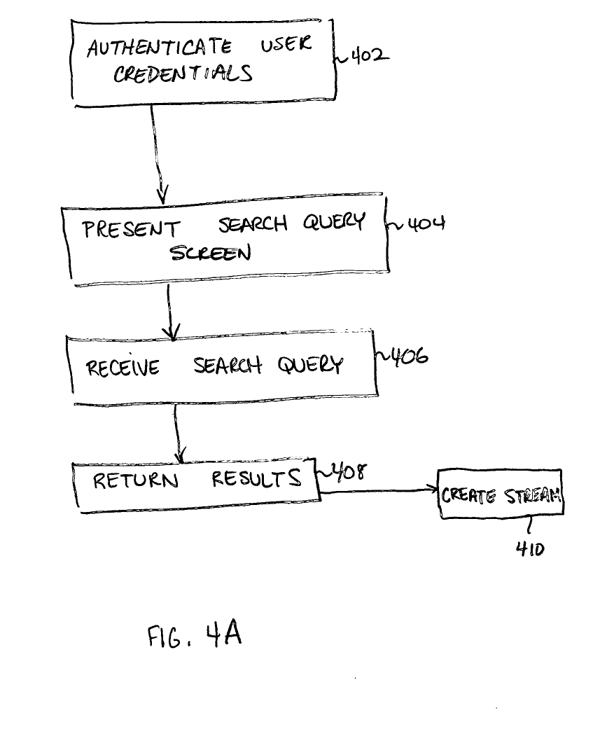

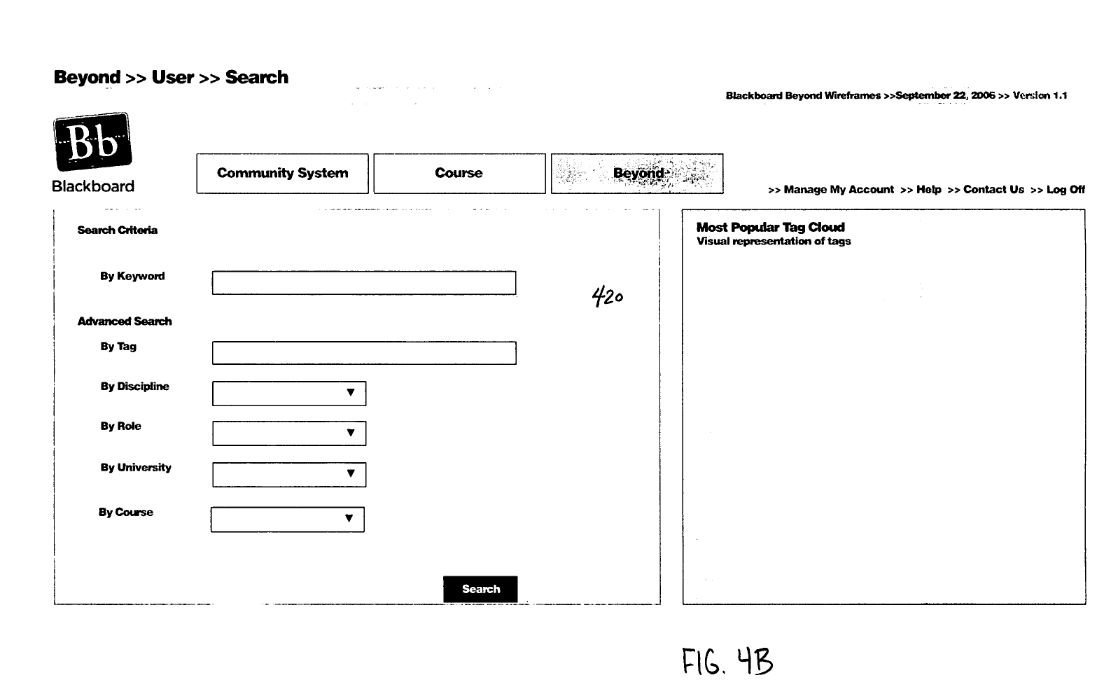

FIG. 4A illustrates a flowchart of an exemplary method for searching the bookmarks that are stored in the community bookmark system. Such a search can take advantage of the collective efforts of the community of users to identify and classify information that is relevant to a topic, a course, a discipline, or some combination of all those elements.

Again, in step 402, a user authenticates with either the community bookmark system, the academic system or both. Once authenticated, the user can select a link or icon so that they are presented, in step 404, with an interface screen that allows entering of a search query. As used herein, a “search query” can include a user-defined query or a predefined query (available, for example, through a link) such as “Most Popular” or “Most Recent”. In step 406, the community bookmark system receives as input a search query from the user and, in response, returns a set of matching bookmarks in step 408. FIG. 4B depicts an exemplary search query screen that allows simple keyword searching of tags and bookmarks. One of ordinary skill will recognize that more complex search interface screens may be used without departing from the scope of the present invention. Regardless of the type of interface presented to a user, search can occur based on a combination of keywords in the bookmark, keywords in the tags, keywords in a “discipline”, the role of the owner of a bookmark, the academic institution of the owner of the bookmark, or a course name. Although not as relevant, other demographic or identifying information could also be used to allow more robust searching such as, for example, the degree of the bookmark's owner, the region of the country of the owner, the country of the owner, or user-supplied ratings of the bookmarks. Some of this information may be automatically retrieved from the academic system associated with the bookmark owner's academic institution or can be generated during account creation and maintenance.

Thus, a variety of attributes about bookmarks, users, and academic institutions may all be used individually or in combination to permit searching of bookmarks, such attributes may, for example, include user, tag, discipline tag, course tag, time created (last hour/day/week/month/year), users' institution, users' roles within the institution, users' degree, users' age, users' state, users' country, users' type of institution (e.g. community college vs. university, or higher education vs. K-12), and user's membership in some group (e.g. all bookmarks from “my friends,” or some sort of membership data from an academic system or other campus system). These attributes could be combined in multiple, complex ways (e.g. all bookmarks with TAG X created in the LAST MONTH by users with the ROLE of faculty at INSTITUTIONS OF TYPE higher education in the STATE of California) and could also be sorted in various ways: by date added (e.g., chronological, reverse chronological); by number of times added (e.g., popularity), by user rating (e.g., highest rated), by number of comments (e.g., most commented upon), or by number of reviews (e.g., most frequently reviewed).

As a result of the search functionality described, the bookmarks stored for the community can be filtered on a variety of different criteria such as the name of an academic institution, a degree type or degree program, whether the owner is a faculty or a student, and the identification of an associated course or section.

Although not depicted on any of the interface screens, a user can label some information as private or non-public. For example, some demographic information may selected for privacy so that a searching user that discovers a matching book mark will not be provided personal identifying information about the bookmark's owner. Also, certain bookmarks may be marked as non-public such that no one other than current user may search for and locate a bookmark so labeled. This selectablility of sharing information can allow users to share information only with other like users or members of a particular group, for example this selectability of sharing information can allow faculty to share information only with other faculty or for owners to share a bookmark only with other members of the same academic institution. One of ordinary skill will recognize that there are many other variations of how bookmarks can be marked and managed as non-public information such that only users matching certain access-control criteria may locate that bookmark.

Once results from a search are returned to a user, that user can choose to create a “stream” for that search, in step 410. A stream is an embeddable object that represents a search of the bookmarks. In one example, a stream is the first n results of the search (e.g., n=5). The stream can be added to a current page or current view of the user so that the user sees the five top results along with a link to the rest of the results. Also, a faculty member who is designing a course page for a particular course could add one or more streams to that course page so that a visitor to the page has the option of selecting the stream. As such, a stream may be a dynamic object so that every time a page is rendered that includes a stream, the results associated with that stream are recalculated with the most current bookmarks stored on the system. A stream may also be updated on the fly such that as a bookmark is added to the system, all streams are updated, including one presently being displayed for a user. Thus, using the community bookmark system, a user can also share, or forward, a stream to another user via an e-mail address or “add” a stream to their homepage to be continuously updated and available. Because streams are effectively embeddable objects, they can be added to almost any portion of the academic system that a user might visit. For example, the initial page of the academic system may include a stream defined by the institution's administrator, while a user's home page may include a different stream that is defined by the user. Each course page may respectively have its own set of relevant streams defined by the instructor and even certain course content pages can include streams as well.

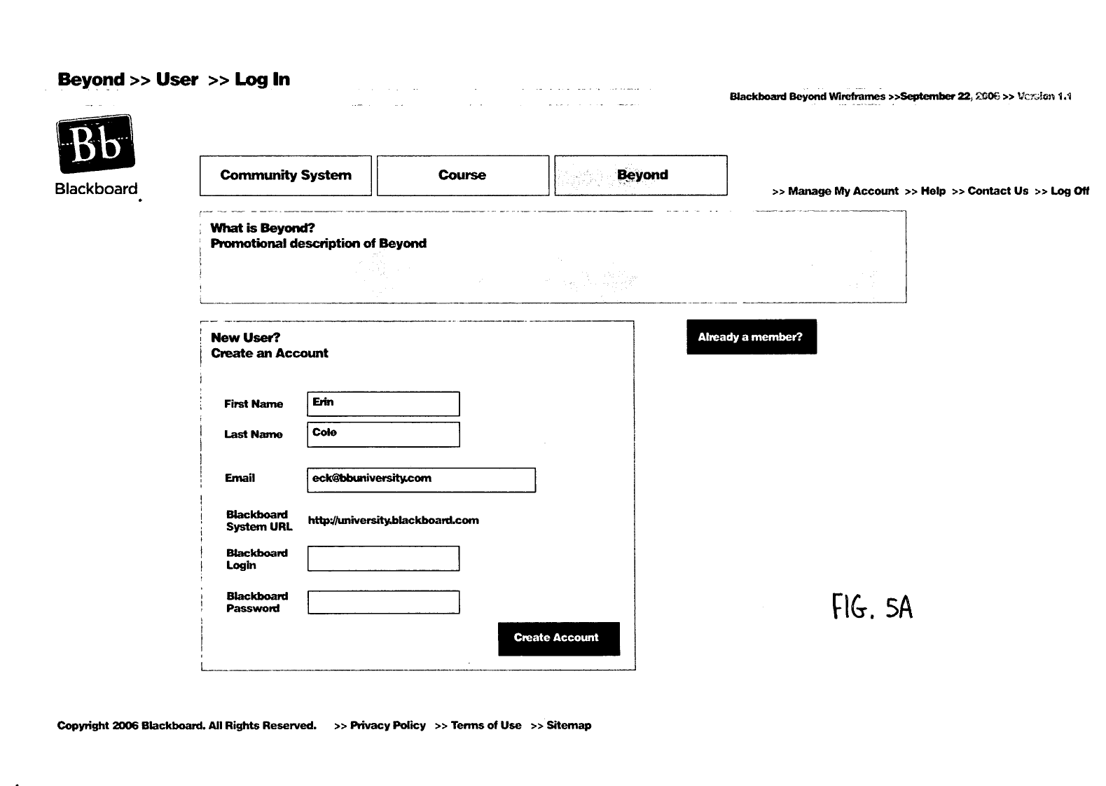

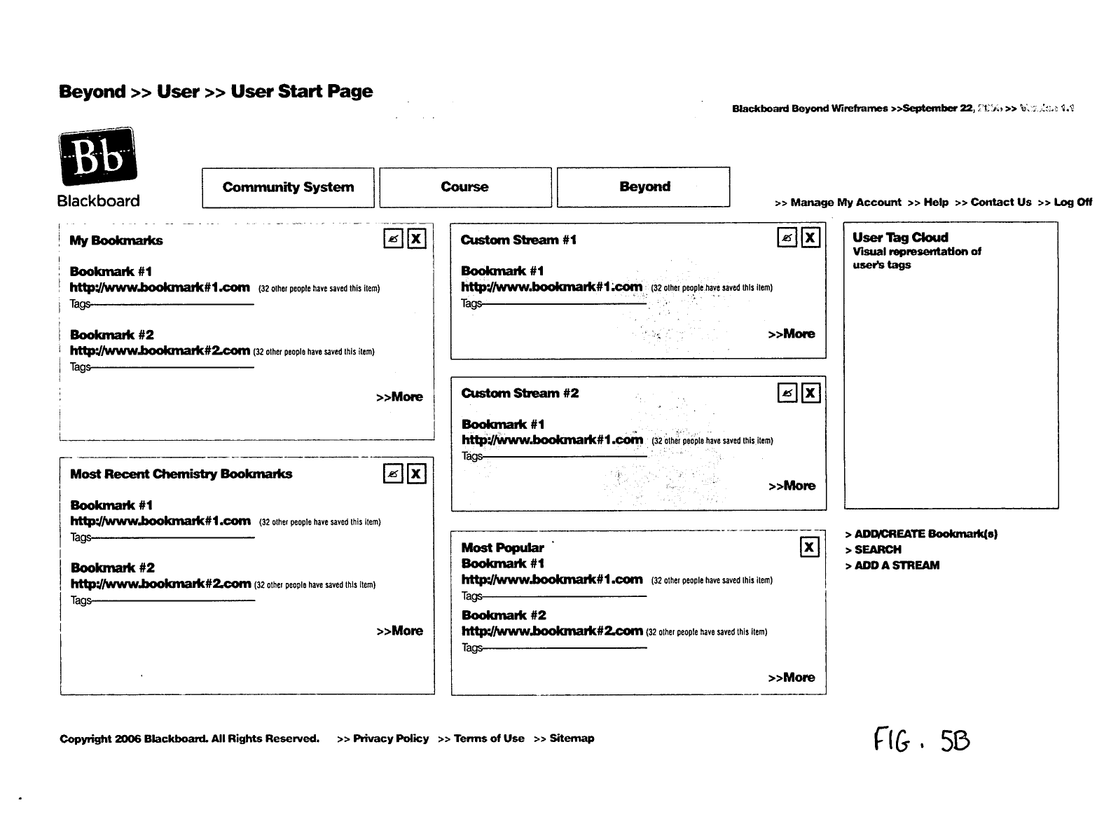

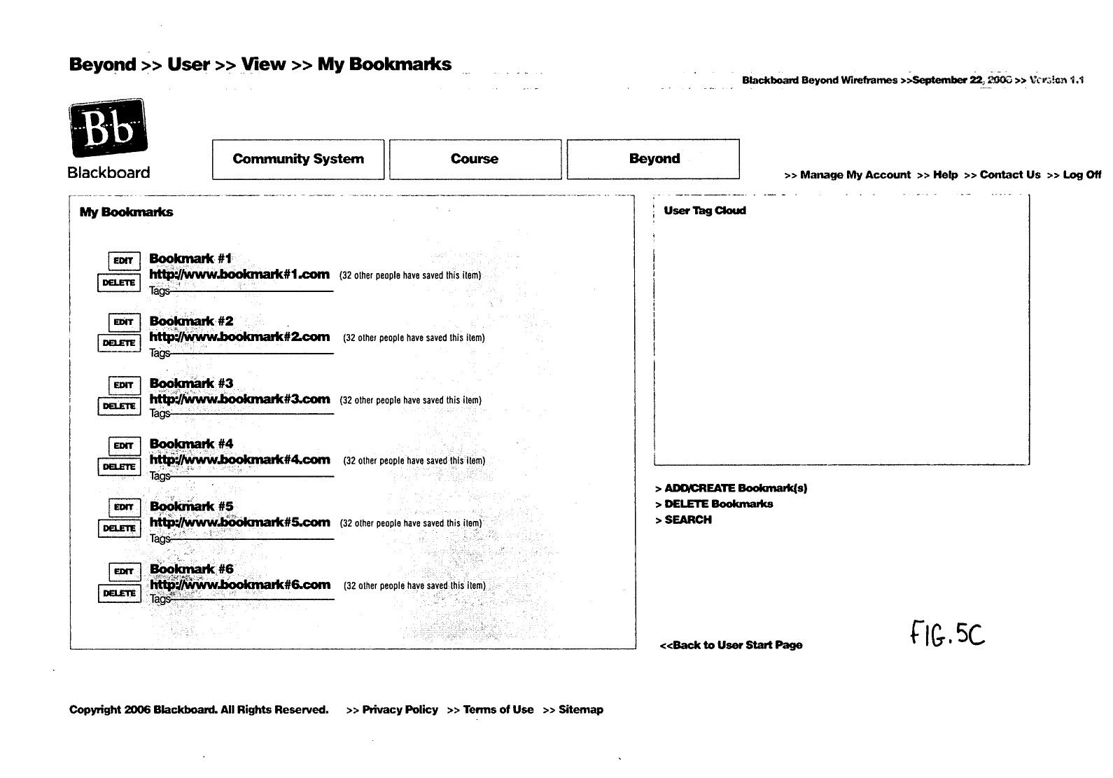

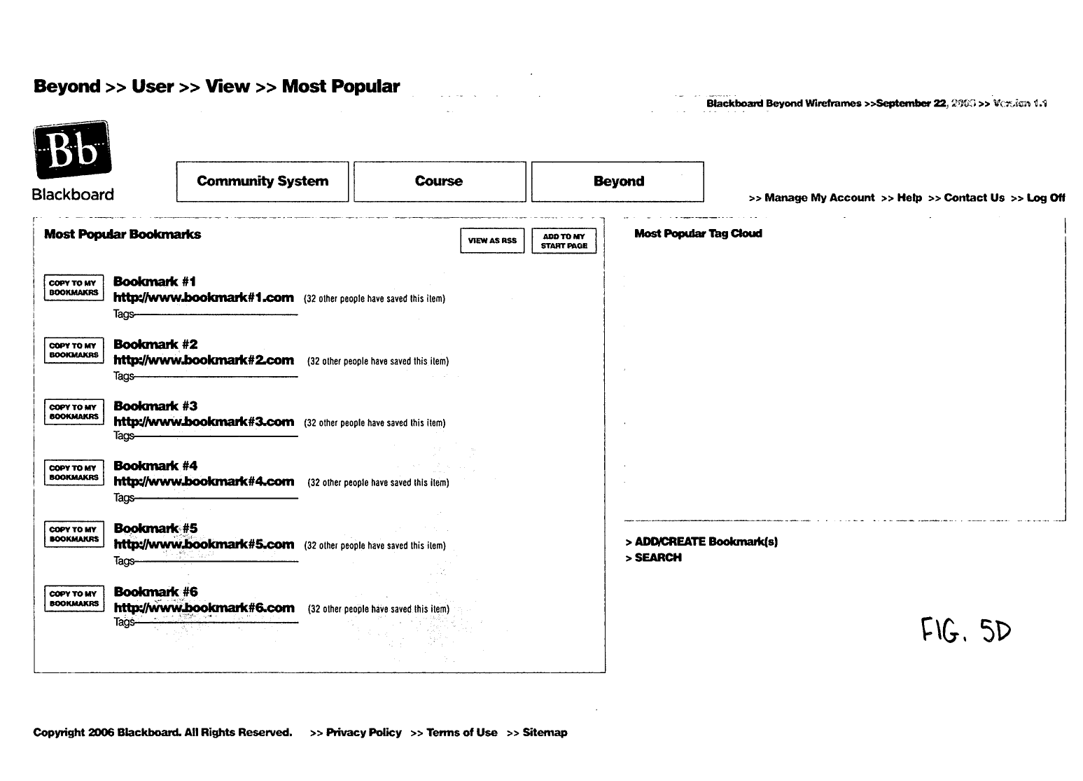

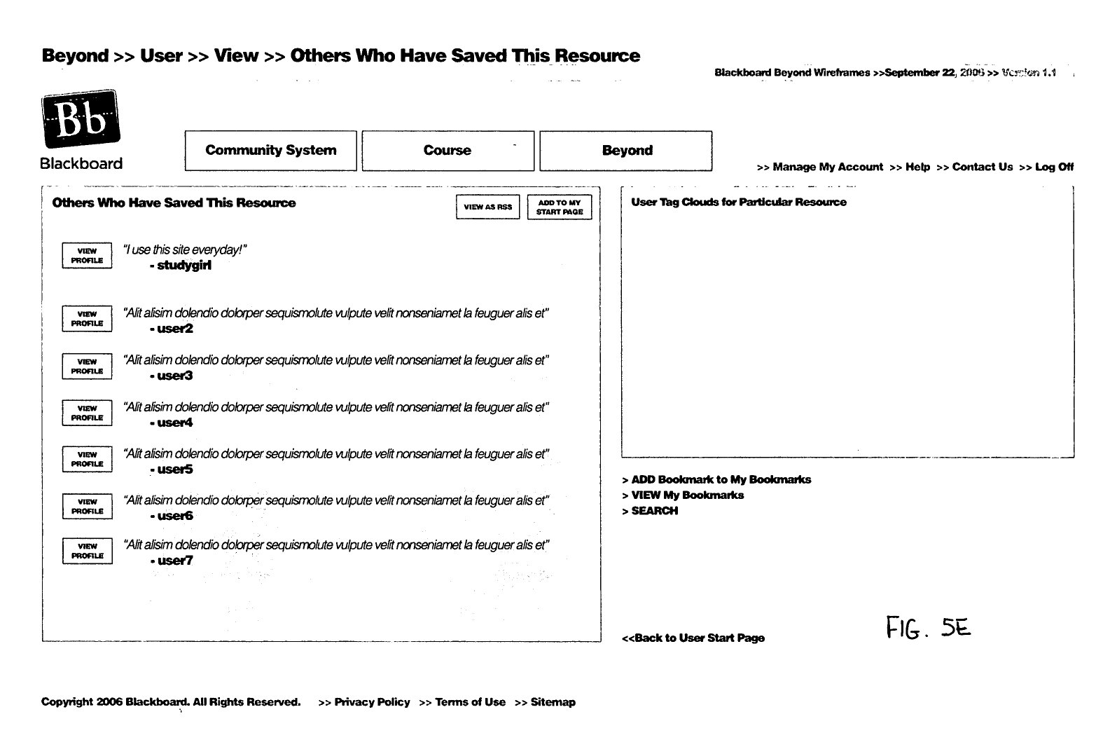

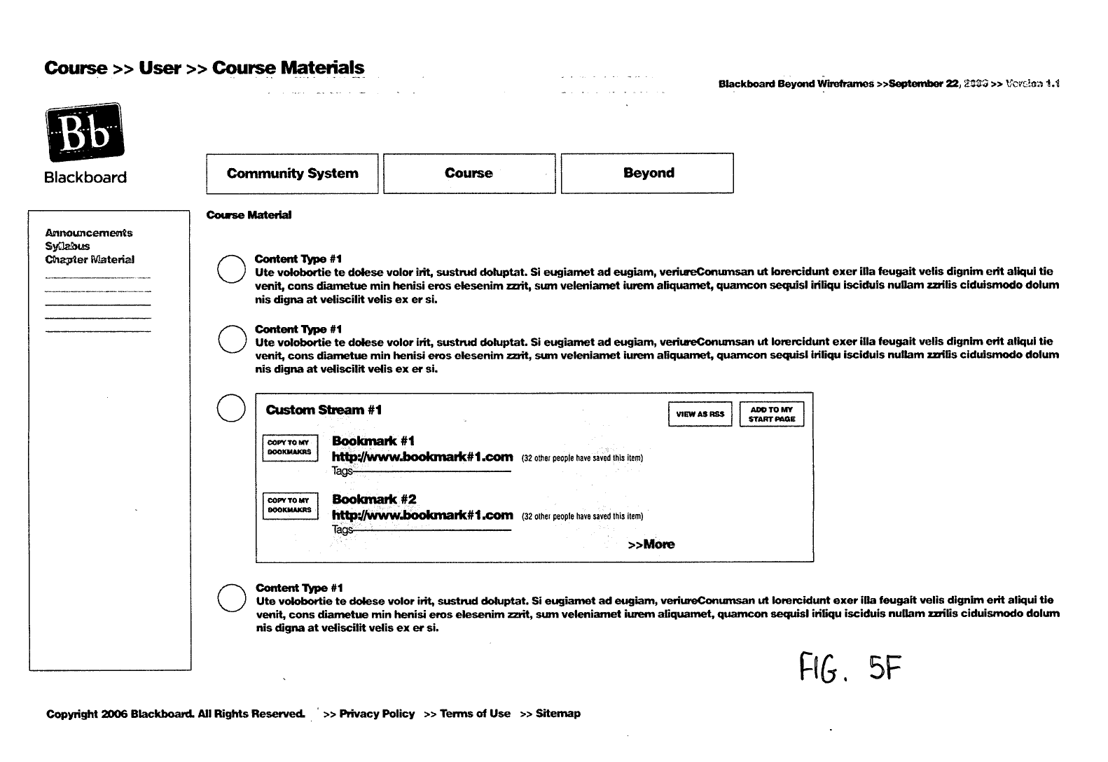

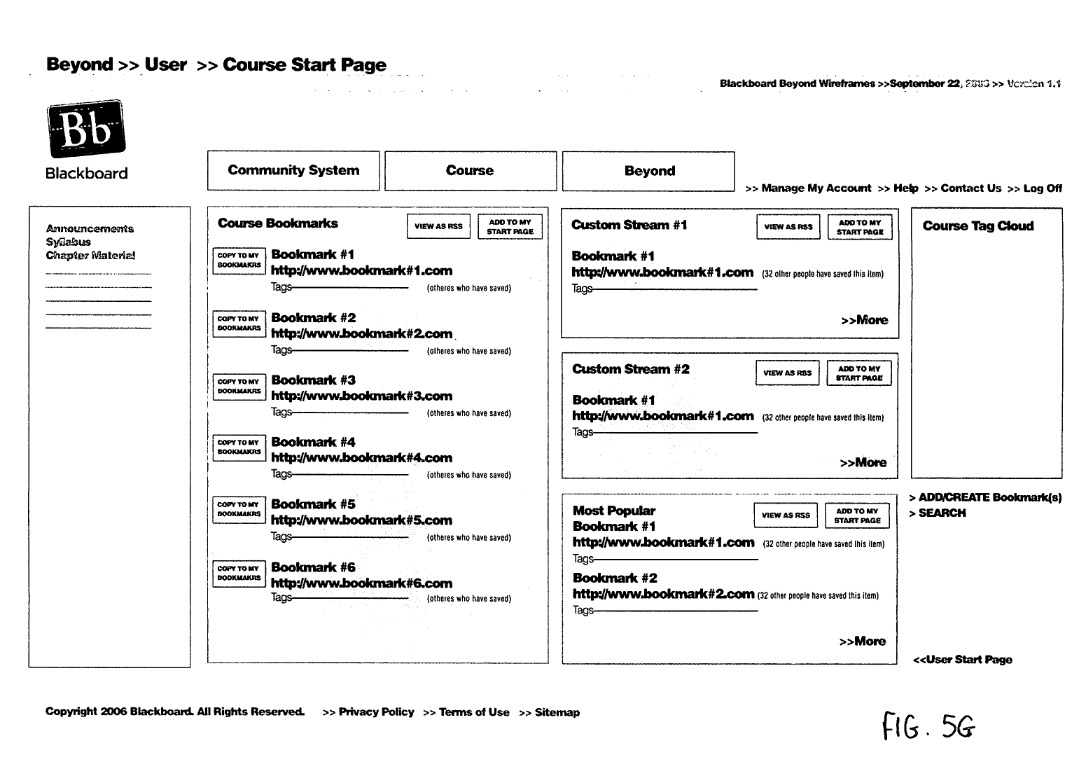

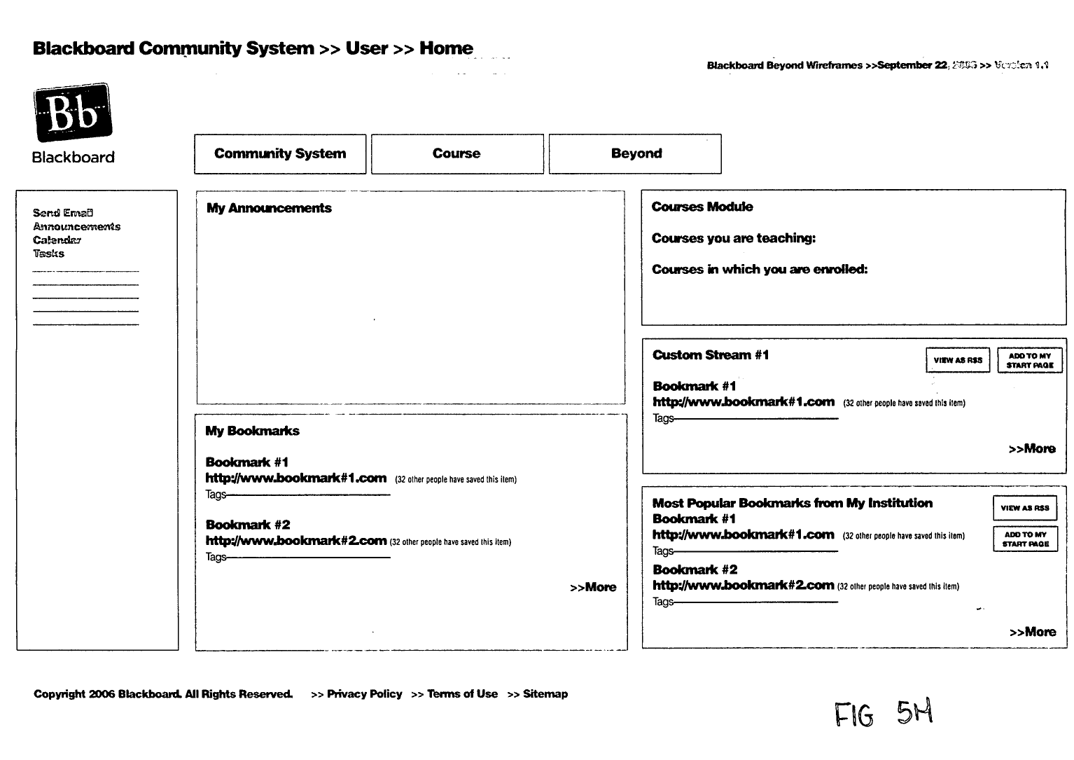

FIGS. 5A-5H depicts exemplary views of a user interface of the community bookmark system or an exemplary academic system. These specific screens are shown merely as a way to explain certain aspects of the present invention. One of ordinary skill will recognize that the screen layout as well as the information on the screens may vary without departing from the scope of the present invention. The interface screens are exemplary in nature and are not intended to limit what type or amount of information may be presented to a user with respect to the community bookmark system.

FIG. 5A depicts an exemplary account creation screen for the community bookmark system that includes both identifying information about the user as well as academic system login information for authenticating the user's credentials vis-à-vis an academic system account. FIG. 5B depicts an exemplary user home, or start, page. This exemplary page includes a region for the user's bookmarks, a discipline-specific stream (e.g. “Chemistry”), and other streams. An area of the page is also included that displays the tags associated with the user's bookmarks in the community bookmark system. This collection of all of a user's associated tags is known as a “tag cloud.” Thus, instead of presenting the user with a number of different bookmarks, the user can be presented with a list of utilized tags. By selecting a tag from the window, the user is presented with a list of their bookmarks having that same tag and would have the option of switching to a view of all user's bookmarks having that same tag. The interface of FIG. 5B is exemplary in nature and may, in other embodiments, include links or jumping-off points for a variety of services and information in addition to merely bookmarks.

FIGS. 5C and 5D depict views of bookmarks that could be generated through user-generated search queries or through pre-defined queries. FIG. 5C has a view of “My Bookmarks” while FIG. 5D has a view of “Most Popular Bookmarks”. FIGS. 5C and 5D represent views of bookmarks that might be accessed by clicking on the “more” link in a stream or by navigating to the view from a tag cloud or by clicking on a link in another view or by a search query. Other typical views which can be defined and readily available for display can, for example, include:

### Most Recent—reverse chronologically-ordered bookmarks added to the system;

### Most Recent tagged with x—the “most recent” that are also tagged appropriately;

### Most Recent tagged with Discipline x—the “most recent” that are also tagged appropriately for a specific discipline;

### Most Recent tagged with Course x—the “most recent” that are also tagged appropriately for a specific course in the academic system;

### My Bookmarks—the bookmarks for the current user;

### My Bookmarks tagged with x—current user's bookmarks that are also tagged appropriately;

### User z Bookmarks—the bookmarks of user z;

### User z Bookmarks tagged with x—user z's bookmarks that are also tagged appropriately;

### Most popular—the bookmarks most popular among all users (or all users having specified attributes, such as all users at a particular institution);

### Most popular tagged with x—the most popular bookmarks that are also tagged appropriately;

### Most popular tagged with Discipline x—the most popular bookmarks that are also tagged appropriately for a particular discipline;

### Most popular tagged with Course x—the most popular bookmarks that are also tagged appropriately for a particular course in the academic system;

### Highest rated—the bookmarks rated highest by all users (or all users having specified attributes, such as all users at a particular institution);

### Highest rated tagged with x—the bookmarks rated highest that are also tagged appropriately;

### Highest rated tagged with Discipline x—the bookmarks rated highest that are also tagged appropriately for a particular discipline;

### Highest rated tagged with Course x—the bookmarks rated highest that are also tagged appropriately for a particular course in the academic system;

### All user that have saved bookmark y—a list of users that also saved a particular bookmark (See FIG. 5E);

### All tags for bookmark x—a list of all tags all the different users have assigned to this bookmark; and

### All tags used by user x—a list of all tags that this user ahs used to describe their bookmarks.

One of ordinary skill will recognize that other customized, pre-defined searches may be included as well.

FIG. 5F shows an exemplary course content screen for a course in an academic system that may be presented to a user of that system. That user, whether or not they have an account with the community bookmark system may access the streams and bookmarks as part of exploring the content for this course. FIG. 5G depicts another course-related page that focuses on available bookmarks, streams, and tags associated with the course. In contrast, FIG. 5H depicts an exemplary initial page for a user of the academic system. From this page, the user has access to the typical course related information but also to resources related to the community bookmark system such as “My Bookmarks” and custom streams. As shown in previous interface screens, the user is presented with various options to added different bookmark views and streams to customize their start page with the information they desire.

A number of variations to the specific behaviors and steps described in the above examples may be made without departing from the scope of the present invention. The various illustrative logical blocks, modules, circuits, elements, and/or components described in connection with the embodiments disclosed herein may be implemented or performed with a general purpose processor, an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, or state machine.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for collecting a plurality of bookmarks comprising the steps of:
authenticating a user of an academic system;
receiving a bookmark from the user;
receiving a tag related to the bookmark; and
storing the tag and the bookmark in a community bookmark repository.

2. The method of claim 1, wherein the tag includes at least one label indicative of the bookmark.

3. The method of claim 1, wherein the step of receiving the tag further includes the steps of:
presenting to the user a plurality of course names;
receiving from the user an identity of a particular course name; and
assigning the particular course name to the tag.

4. The method of claim 3, wherein the plurality of course names includes current courses in which the user can access via the academic system.

5. The method of claim 1, wherein the step of receiving the tag further includes the steps of:
presenting to the user a plurality of academic disciplines;
receiving from the user an identity of a particular academic discipline; and
assigning the particular academic discipline to the tag.

6. The method of claim 5, wherein the plurality of academic disciplines include a hierarchically arranged list of disciplines.

7. The method of claim 5, wherein the plurality of academic disciplines include a selected subset of available disciplines identified by the user.

8. The method of claim 1, wherein at least a portion of the tag is received from the academic system.

9. The method of claim 1, wherein at least a portion of the tag is received from the user.

10. A community bookmark system, comprising:
an authentication module configured to authenticate a user of an academic system in communication with the community bookmark system;
a receiver configured to receive from the user a bookmark;
the receiver further configured to receive from the user a tag related to the bookmark; and
a data repository configured to store the bookmark and the tag.

11. The system of claim 10, wherein the tag includes at least one label indicative of the bookmark.

12. The system of claim 10, wherein:
the receiver is further configured to receive from the academic system a plurality of course names and to receive from the user an identity of a particular course name from among the plurality of course names such that the particular course name is assigned to the tag.

13. The system of claim 12, wherein the plurality of course names includes current courses in which the user can access via the academic system.

14. The system of claim 10, wherein:
the receiver is further configured to receive from the user an identity of a particular academic disciplines from among a plurality of academic disciplines such that the particular academic discipline is assigned to the tag.

15. The system of claim 14, wherein the plurality of academic disciplines are received from the academic system.

16. The system of claim 14, wherein the plurality of academic disciplines include a hierarchically arranged list of disciplines store within the data repository.

17. The system of claim 10, wherein at least a portion of the tag is received from the academic system.

18. The system of claim 10, wherein at least a portion of the tag is received from the user.

20. A method for providing bookmarks from a community bookmark repository, comprising the steps of:
authenticating a user of an academic system in communication with the community bookmark repository;
presenting a query interface to the user;
receiving a search query from the user;
locating one or more bookmarks in the community bookmark repository matching the search query; and
presenting the located one or more bookmarks to the user.

21. The method of claim 20, wherein the search query relates to a tag assigned to respective bookmarks within the community bookmark repository.

22. The method of claim 20, wherein the search query relates to a course name associated with respective bookmarks within the community bookmark repository.

23. The method of claim 20, wherein the search query relates to an academic discipline associated with respective bookmarks within the community bookmark repository.

24. The method of claim 20, wherein the search query relates to an attribute of an owner associated with respective bookmarks within the community bookmark repository.

25. The method of claim 20, wherein the search query relates to an academic institution of an owner associated with respective bookmarks within the community bookmark repository.

26. The method of claim 20, wherein the search query relates to a course name associated with respective bookmarks within the community bookmark repository.

27. The method of claim 20, further comprising the step of:
saving a stream related to the search query

28. The method of claim 27, further comprising the steps
embedding the stream in a web page presented to the user; and
dynamically executing the search query when the web page is rendered to the user.

29. The method of claim 27, further comprising the steps of:
receiving from the user an identity of a web page in which to embed the stream; and
embedding the stream in the identified web page.

30. The method of claim 29, wherein the identified web page is presented by the academic system.

31. The method of claim 30, wherein the identified web page is one of: a course content page, a course page, the user's home page, and the academic system's main page.
